(19) United States
(12) Patent Application Publication
(10) Pub. No.: US 2026/0120425 A1
(43) Pub. Date: Apr. 30, 2026

(54) 3D POINT CLOUD SEGMENTATION DEVICE, 3D POINT CLOUD SEGMENTATION METHOD, AND 3D POINT CLOUD SEGMENTATION PROGRAM

(71) Applicant: NIPPON TELEGRAPH AND TELEPHONE CORPORATION, Tokyo (JP)

(72) Inventors: Yasuhiro YAO, Tokyo (JP); Kana KURATA, Tokyo (JP); Jun SHIMAMURA, Tokyo (JP); Shingo ANDO, Tokyo (JP)

(73) Assignee: NIPPON TELEGRAPH AND TELEPHONE CORPORATION, Tokyo (JP)

(21) Appl. No.: 18/851,142

(22) PCT Filed: Mar. 30, 2022
(86) PCT No.: PCT/JP2022/016241

§ 371 Date: Sep. 26, 2024

(51) Int. Cl. G06V 10/26; G06V 10/40; G06V 10/764; G06V 10/774; G06V 20/64

(52) U.S. Cl. CPC G06V 10/26; G06V 10/40; G06V 10/764; G06V 10/774; G06V 20/64

(57) ABSTRACT

A search unit (24) searches for neighboring point clouds for points included in a first three-dimensional point cloud, the points each having three-dimensional coordinates, from a second three-dimensional point cloud in which a density of points included is higher than that of the first three-dimensional point cloud, the points each having three-dimensional coordinates and information derived from an image, and an inference unit (26) infers an object corresponding to each point included in the first three-dimensional point cloud on the basis of features extracted from the neighboring point clouds found by the search unit (24).

### TECHNICAL FIELD

The disclosed technique relates to a three-dimensional point cloud segmentation device, a three-dimensional point cloud segmentation method, and a three-dimensional point cloud segmentation program.

### BACKGROUND ART

In the related art, many methods have been proposed for performing semantic segmentation on three-dimensional point clouds using deep learning. For example, PointNet++, KPConv, and the like have been reported in recent years as Segmentation methods (NPL 1 and 2).

Generally, in order to accurately measure a three-dimensional point, measurement is performed using a time of flight (TOF) distance sensor such as LiDAR. In the case of LiDAR, a laser pulse is irradiated to the surrounding area, and the distance to the target is acquired from the time it takes for the laser pulse to be reflected back to LiDAR. Furthermore, since the laser irradiation direction is also known, the three-dimensional coordinates of each point are acquired on the basis of the distance and direction information.

However, in the case of LiDAR, three-dimensional points can only be measured within the number of irradiated pulses, and as a result, the acquired three-dimensional point cloud may have a low density. In particular, the lower the price of LiDAR, the smaller the number of pulses it irradiates in a certain period of time, and the measured point cloud tends to have a lower density.

Furthermore, regarding the density of point clouds, a method has been proposed that uses images to increase the density of low-density point clouds (PTL 1 and NPL 3).

### CITATION LIST

### Patent Literature

[PTL 1] Japanese Patent Application Publication No. 2021-174406

### Non Patent Literature

[NPL 1] Qi, C. R., Yi, L., Su, H., & Guibas, L. J., “PointNet++: Deep Hierarchical Feature Learning on Point Sets in a Metric Space,” Advances in Neural Information Processing Systems, 30, 2017

[NPL 2] Thomas, H., Qi, C. R., Deschaud, J. E., Marcotegui, B., Goulette, F., & Guibas, L. J., “Kpconv: Flexible and deformable convolution for point clouds,” In Proceedings of the IEEE/CVF International Conference on Computer Vision (pp. 6411-6420), 2019

[NPL 3] Yao, Y., Ishikawa, R., Ando, S., Kurata, K., Ito, N., Shimamura, J., & Oishi, T., “Non-Learning Stereo-Aided Depth Completion Under Mis-Projection via Selective Stereo Matching,” IEEE Access, 9, 136674-136686, 2021

### SUMMARY OF INVENTION

### Technical Problem

In the related art such as those disclosed in NPL 1 and 2, features are extracted only from a target three-dimensional point cloud to perform segmentation. Therefore, due to the low density of the target three-dimensional point cloud, the shape features of the object cannot be captured, resulting in information loss and segmentation failure.

Furthermore, even if a low-density three-dimensional point cloud is densified by simply applying the related art such as those disclosed in PTL 1 and NPL 3, there is a likelihood that a sufficiently accurate segmentation result will not be obtained.

The present disclosure has been made in view of the above points, and an object of the present disclosure is to accurately perform segmentation of a three-dimensional point cloud.

### Solution to Problem

A first aspect of the present disclosure relates to a three-dimensional point cloud segmentation device including: a search unit that searches for neighboring point clouds for points included in a first three-dimensional point cloud, the points each having three-dimensional coordinates, from a second three-dimensional point cloud in which a density of points included is higher than that of the first three-dimensional point cloud, the points each having three-dimensional coordinates and information derived from an image; and an inference unit that infers an object corresponding to each point included in the first three-dimensional point cloud on the basis of features extracted from the neighboring point clouds found by the search unit.

A second aspect of the present disclosure relates to a three-dimensional point cloud segmentation method including: searching for, by a search unit, neighboring point clouds for points included in a first three-dimensional point cloud, the points each having three-dimensional coordinates, from a second three-dimensional point cloud in which a density of points included is higher than that of the first three-dimensional point cloud, the points each having three-dimensional coordinates and information derived from an image; and inferring, by an inference unit, an object corresponding to each point included in the first three-dimensional point cloud on the basis of features extracted from the neighboring point clouds found by the search unit.

A third aspect of the present disclosure is a three-dimensional point cloud segmentation program, which is a program for causing a computer to function as each unit of the three-dimensional point cloud segmentation device described above.

### Advantageous Effects of Invention

According to the disclosed technique, it is possible to accurately perform segmentation of a three-dimensional point cloud.

### BRIEF DESCRIPTION OF DRAWINGS

FIG. 1 is a block diagram illustrating a hardware configuration of a three-dimensional point cloud segmentation device.

FIG. 2 is a functional block diagram of the three-dimensional point cloud segmentation device.

FIG. 3 is a diagram for describing an example of input data.

FIG. 4 is a diagram for describing an example of densification.

FIG. 5 is a diagram for describing an example of a search for a neighboring point cloud.

FIG. 6 is a diagram for describing an example of an inference model.

FIG. 7 is a flowchart illustrating an example of learning processing.

FIG. 8 is a flowchart illustrating an example of inference processing.

FIG. 9 is a diagram for describing an example of experimental results.

FIG. 10 is a diagram for describing an example of a segmentation result.

### DESCRIPTION OF EMBODIMENTS

An example of an embodiment of the disclosed technique will be described below with reference to the drawings. In the drawings, the same or equivalent components and portions are denoted by the same reference signs. Further, dimensional ratios in the drawings are exaggerated for convenience of description and thus may be different from actual ratios.

First, an overview of the present embodiment will be described.

A three-dimensional point cloud segmentation device according to the present embodiment is a device that performs semantic segmentation learning and inference on a low-density three-dimensional point cloud (hereinafter referred to as a “three-dimensional point cloud A”) measured by low-resolution LiDAR or the like.

The three-dimensional point cloud segmentation device according to the present embodiment receives the three-dimensional point cloud A as an input, and generates a point cloud (hereinafter referred to as a “densified point cloud B”) obtained by densifying the three-dimensional point cloud A using an image. That is, the density of points included in each point cloud is higher in the densified point cloud B than in the three-dimensional point cloud A. Therefore, in the present embodiment, in comparing the three-dimensional point cloud A and the densified point cloud B, the density of the three-dimensional point cloud A is defined as low density, and the density of densified point cloud B is defined as high density.

Further, the three-dimensional point cloud segmentation device learns the parameters of an inference model for performing segmentation, and performs inference, that is, segmentation of the three-dimensional point cloud, using the inference model to which the learned parameters are applied. Furthermore, the three-dimensional point cloud segmentation device also updates parameters used when densifying the three-dimensional point cloud A using the aforementioned learning labels for segmentation (details will be described later).

Next, the configuration of the three-dimensional point cloud segmentation device according to the present embodiment will be described.

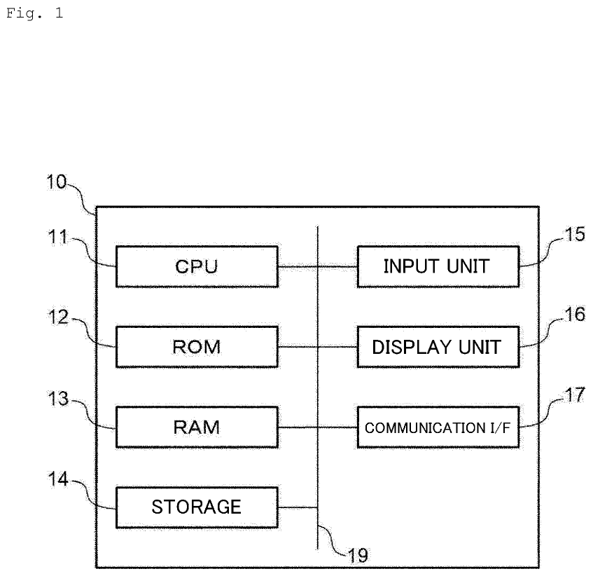

FIG. 1 is a block diagram illustrating a hardware configuration of a three-dimensional point cloud segmentation device 10 according to the present embodiment. As illustrated in FIG. 1, the three-dimensional point cloud segmentation device 10 includes a central processing unit (CPU) 11, a read only memory (ROM) 12, a random access memory (RAM) 13, a storage 14, an input unit 15, a display unit 16, and a communication interface (I/F) 17. The components are communicatively connected to each other via a bus 19.

The CPU 11 is a central processing unit, which executes various programs and controls each component. That is, the CPU 11 reads out the programs from the ROM 12 or the storage 14 and executes the programs by using the RAM 13 as a work area.

The CPU 11 controls each component described above and performs various types of arithmetic processing according to the programs stored in the ROM 12 or the storage 14. In the present embodiment, the ROM 12 or the storage 14 stores a three-dimensional point cloud segmentation program for executing learning processing and inference processing, which will be described later.

The ROM 12 stores various programs and various types of data. The RAM 13 serving as a work area temporarily stores programs and data. The storage 14 is constituted by a storage device such as a hard disk drive (HDD) or a solid state drive (SSD), and stores various programs including an operating system and various types of data.

The input unit 15 includes, for example, a pointing device such as a mouse and a keyboard and is used to perform various inputs. The display unit 16 is, for example, a liquid crystal display and displays various types of information. The display unit 16 may function as the input unit 15 by employing a touch panel system.

The communication I/F 17 is an interface for communicating with other devices. For example, a wireless communication standard such as 4G, 5G, or Wi-Fi (registered trademark) is used for the communication.

Next, a functional configuration of the three-dimensional point cloud segmentation device 10 according to the present embodiment will be described.

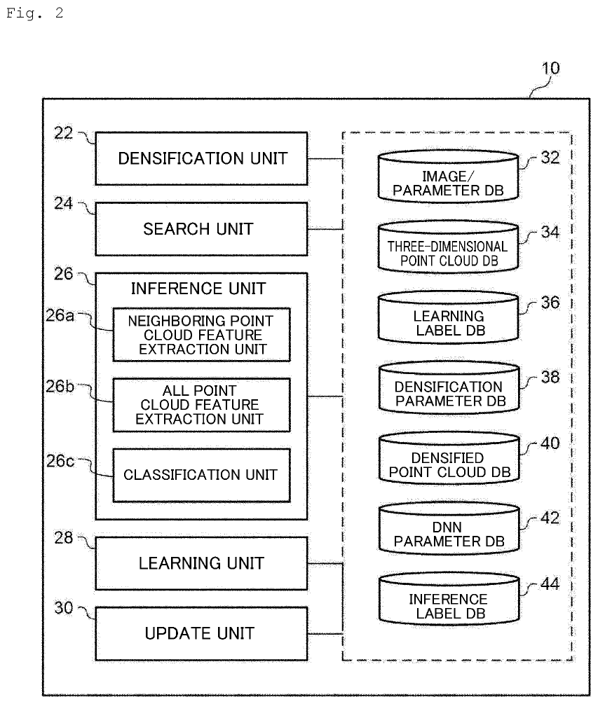

FIG. 2 is a block diagram illustrating an example of a functional configuration of the three-dimensional point cloud segmentation device 10. As illustrated in FIG. 2, the three-dimensional point cloud segmentation device 10 includes, as a functional configuration, a densification unit 22, a search unit 24, an inference unit 26, a learning unit 28, and an update unit 30. Further, the inference unit 26 includes a neighboring point cloud feature extraction unit 26a, an all point cloud feature extraction unit 26b, and a classification unit 26c. Furthermore, the three-dimensional point cloud segmentation device 10 manages various types of information using a database. The database includes, for example, an image/parameter database (DB) 32, a three-dimensional point cloud DB 34, a learning label DB 36, a densification parameter DB 38, and a densified point cloud DB 40. Further, the database includes, for example, a deep neural network (DNN) parameter DB 42 and an inference label DB 44. Each functional configuration is implemented by the CPU 11 reading out a three-dimensional point cloud segmentation program stored in the ROM 12 or the storage 14, loading the program into the RAM 13, and executing the program.

The densification unit 22 generates a densified point cloud B by densifying the three-dimensional point cloud A on the basis of the correspondence between the three-dimensional point cloud A and an image A obtained by imaging a space including the three-dimensional point cloud A. Specifically, the densification unit 22 acquires, as input data, the three-dimensional point cloud A, a densification parameter Pδ, the image A, internal parameters of a camera, and external parameters of the camera from the corresponding database.

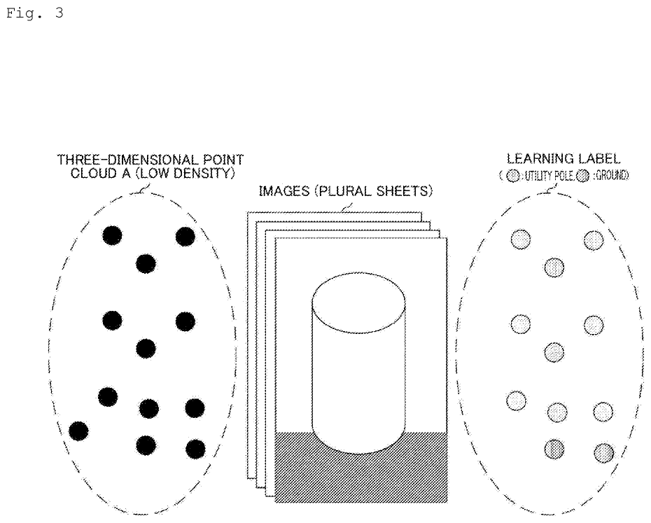

The three-dimensional point cloud A is stored in the three-dimensional point cloud DB 34. The three-dimensional point cloud A is schematically illustrated on the left side of FIG. 3. The three-dimensional point cloud A is point cloud data in which each point has three-dimensional coordinates. The three-dimensional point cloud A is a low-density point cloud acquired by measurement such as LiDAR, but it is a three-dimensional point cloud with accurate position information and less noise. Note that it is assumed that the number of points included in the three-dimensional point cloud A is the number (L) of points for which an inference model, which will be described later, infers a label at one time. When the number of points included in the three-dimensional point cloud is larger than L, the three-dimensional point cloud A is processed in advance so that the number of input points becomes L.

The image A is stored in the image/parameter DB 32. An example of the image A is illustrated in the center of FIG. 3. The image A is an image obtained by imaging a space including the three-dimensional point cloud A, that is, a location where the three-dimensional point cloud A was measured. The position and orientation of the camera that captured the image A are known from external parameters (rotation and translation in the three-dimensional space) with respect to the origin of the coordinate system of the three-dimensional point cloud A. Three-dimensional coordinates are converted into two-dimensional coordinates of an image using the position and orientation of the camera specified by the external parameters and the internal parameters of the camera. The external parameters and internal parameters of the camera are stored in the image/parameter DB 32 in association with the image A. In addition, the number of images A for one three-dimensional point cloud A is (K) according to the densification method to be described later, and the external parameters of the camera and the internal parameters of the camera are set for each of the K images A.

The densification parameter Po is a set of a plurality of parameters according to the densification method to be described later, and is stored in the densification parameter DB 38. At the initial stage of learning, the densification parameter DB 38 stores a predetermined default value as the densification parameter Pδ. Further, at the time of inference, the final densification parameter Pδ updated at the time of learning is stored in the densification parameter DB 38.

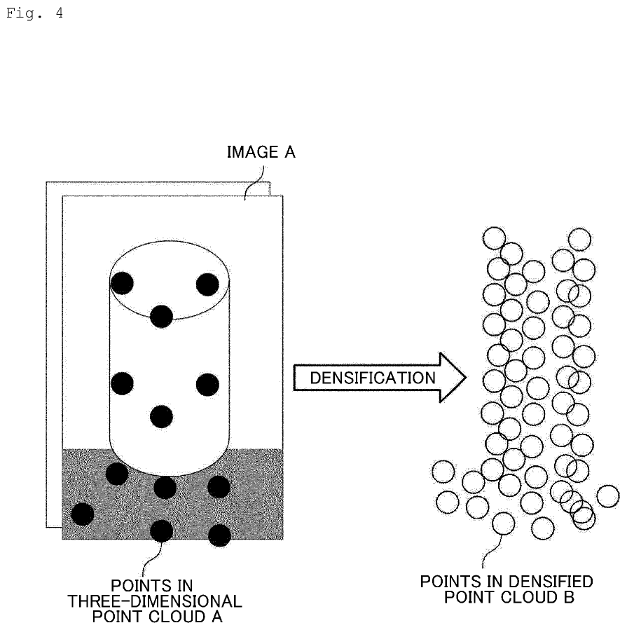

Specifically, as shown in FIG. 4, the densification unit 22 associates the three-dimensional point cloud A with the image A, applies the densification parameter Pδ to densify the three-dimensional point cloud A using the image A as a clue, and generates the densified point cloud B. The densification unit 22 may use, for example, the method of PTL 1 or NPL 3 as the densification method. An example of a densification method will be described below.

The densification unit 22 converts the three-dimensional point cloud A into a depth map a using external parameters and internal parameters of the camera. Since the depth map a is created by projecting each point in the low-density three-dimensional point cloud A onto the image, most pixels have no value. The densification unit 22 inputs the depth map a and the image A, performs densification processing, and generates a depth map b in which all pixels have depth values. The densification unit 22 converts the depth map b again into a three-dimensional point cloud using the external parameters and internal parameters of the camera, and generates a three-dimensional point cloud b. The densification unit 22 generates a three-dimensional point cloud b for each of the K images A, and generates a densified point cloud B in which the K three-dimensional point clouds b are grouped together.

The densification unit 22 stores the generated densified point cloud B in the densified point cloud DB 40. Note that the densified point cloud B has a larger error in position information than a point cloud measured by a TOF distance sensor, but is a three-dimensional point cloud with a higher density. In addition, each pixel of the image A has color information, and the densified point cloud B generated using the image A also retains information derived from such an image (hereinafter referred to as “image-derived information”).

The search unit 24 acquires the densified point cloud B from the densified point cloud DB 40, searches for the neighborhood of each point in the three-dimensional point cloud A from the densified point cloud B, and acquires a group of neighboring points (hereinafter referred to as a “neighboring point cloud C”). When the number of points included in the three-dimensional point cloud A is L, and N neighboring points are acquired for each point in the three-dimensional point cloud A, the number of points included in the neighboring point cloud C is L points×N. Furthermore, when each point in the densified point cloud B has m-dimensional information, the neighboring point cloud C has L points×N×m-dimensional information.

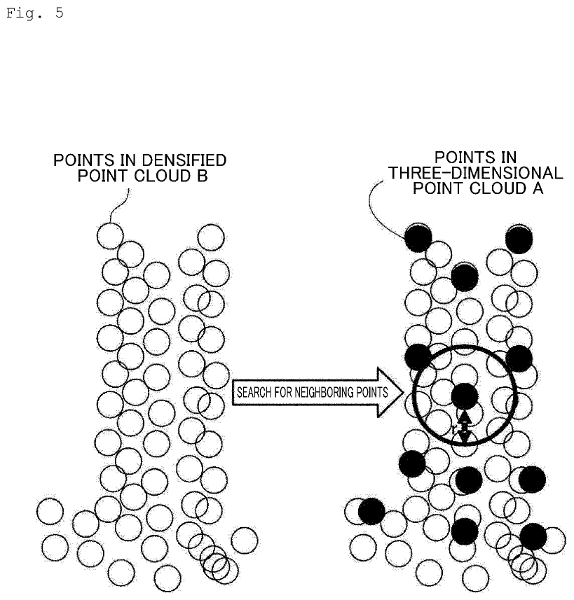

Specifically, as illustrated in FIG. 5, the search unit 24 samples a predetermined number of (here, N) points among the points of the densified point cloud B included within a radius r of a point a included in the three-dimensional point cloud A (right side in FIG. 5) with the densified point cloud B and the three-dimensional point cloud A superimposed. The search unit 24 acquires a set of sampled points as the neighboring point cloud C of the point a.

More specifically, the search process is performed in the following order, for example.
1. A KD tree (T_B) is constructed from the densified point cloud B.
2. For the point a included in the three-dimensional point cloud A, T_B is used to obtain a subset (B_a) of the densified point cloud B included within a radius r from the point a.
3. For the element of B_a, coordinate transformation is performed by parallel movement to relative coordinates with the point a as the origin.
4. When the number of elements in B_a is greater than N, N points are randomly sampled from B_a.
5. When the number of elements of B_a is smaller than N, an element in which all elements are zero is added to B_a, and the number of elements is set to N.
6. Steps 2 to 5 are performed for all points (L points) included in the three-dimensional point cloud A to obtain a neighboring point cloud C (L points×N×m dimension).

The inference unit 26 includes the neighboring point cloud feature extraction unit 26a, the all point cloud feature extraction unit 26b, and the classification unit 26c, and infers an object corresponding to each point included in the three-dimensional point cloud A on the basis of the features extracted from the neighboring point cloud C found by the search unit 24. Specifically, the inference unit 26 inputs the neighboring point cloud C into an inference model for inferring a label indicating an object corresponding to each point in the three-dimensional point cloud A, and acquires an inference label output from the inference model. The inference unit 26 passes the acquired inference label to the learning unit 28 and the update unit 30 during learning, and stores the acquired inference label in the inference label DB 44 during inference.

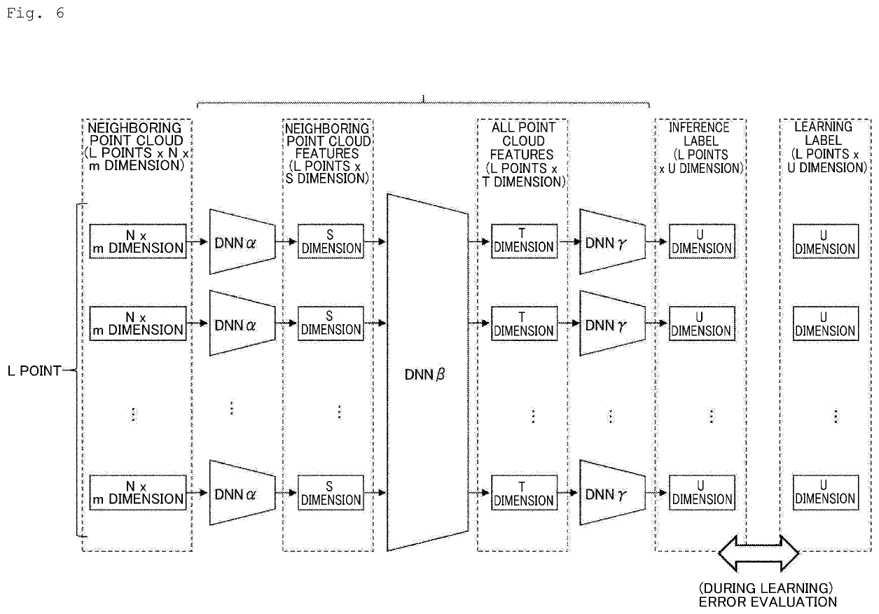

In the present embodiment, for example, as illustrated in FIG. 6, an inference model including three types of DNNs, DNNα, DNNβ, and DNNγ, is used. A DNN parameter Pα of DNNα, a DNN parameter Pβ of DNNβ, and a DNN parameter Pγ of DNNγ are stored in the DNN parameter DB 42. Each of the DNN parameters Pα, Pβ, and Pγ is a set of a plurality of parameters, specifically, DNN edge weights and bias values. At the initial stage of learning, the DNN parameter DB 42 stores DNN parameters Pα, Pβ, and Pγ initialized by random numbers. Furthermore, during inference, the final DNN parameters Pα, Pβ, and Pγ updated during learning are stored in the DNN parameter DB 42.

Hereinafter, details of the neighboring point cloud feature extraction unit 26a, the all point cloud feature extraction unit 26b, and the classification unit 26c, as well as details of DNNα, DNNβ, and DNNγ will be described.

The neighboring point cloud feature extraction unit 26a uses DNNα independently for each point in the three-dimensional point cloud A to extract a feature of the neighboring point cloud C found for each point. Specifically, the neighboring point cloud feature extraction unit 26a receives the neighboring point cloud C from the search unit 24 as input data, and acquires the DNN parameter Pα from the DNN parameter DB 42. The neighboring point cloud feature extraction unit 26a inputs the neighboring point cloud C for each of the L points of the three-dimensional point cloud A to L DNNα's set with the same DNN parameter Pα. DNNα independently applies convolutional neural network (CNN) processing to the input of the neighboring point cloud C of N×m dimension. More specifically, DNNα applies convolution, activation, batch normalization, and dropout processing across a plurality of layers. Accordingly, DNNα outputs S-dimensional features for each neighboring point cloud C. By performing the above processing on L points by L DNNα's, the neighboring point cloud feature extraction unit 26a derives a neighboring point cloud feature F_C of L points×S dimension.

The all point cloud feature extraction unit 26b uses one DNNβ for the three-dimensional point cloud A to extract features for classifying the object corresponding to each point included in the three-dimensional point cloud A from the neighboring point cloud features F_C extracted by the neighboring point cloud feature extraction unit 26a. Specifically, the all point cloud feature extraction unit 26b receives the neighboring point cloud features F_C from the neighboring point cloud feature extraction unit 26a as input data, and acquires the DNN parameter Pβ from the DNN parameter DB 42. The all point cloud feature extraction unit 26b inputs the neighboring point cloud feature F_C of L points×S dimension to DNNβ in which the DNN parameter Pβ is set, and derives all point cloud features F of L points×T dimension. DNNβ may be, for example, a known three-dimensional point cloud segmentation module such as Pointnet++ or KPConv.

The classification unit 26c uses DNNγ for classifying the object corresponding to each point to classify the object corresponding to each point included in the three-dimensional point cloud A from the features extracted by the all point cloud feature extraction unit 26b. Specifically, the classification unit 26c receives the all point cloud features F from the all point cloud feature extraction unit 26b as input data, and acquires the DNN parameter Pγ from the DNN parameter DB 42. The classification unit 26c inputs the all point cloud features F of L points×T dimension to DNNγ in which the DNN parameter Pγ is set. DNNγ independently estimates labels for L points and outputs inference labels of L points×U dimension. DNNγ is composed of, for example, multi-layer perceptron and softmax layers, and may output a one hot encoded inference label.

Since three-dimensional point clouds measured by LiDAR or the like generally do not capture the color of objects, color information cannot often be utilized, and this may be a cause of segmentation errors. Further, in the case of LiDAR, three-dimensional points can only be measured within the number of irradiated pulses, and as a result, the acquired three-dimensional point cloud may have a low density. In the present embodiment, as described above, a low-density three-dimensional point cloud A measured by LiDAR or the like is densified using an image, and features of a neighboring point cloud C having image-derived information are extracted. This feature includes color information and texture information based on image-derived information. Since it has gone through a process of densification, the features include surface information that could not be captured by the low-density three-dimensional point cloud A. In the present embodiment, by performing segmentation using this feature, segmentation can be performed more accurately than in the case where segmentation is performed only using position information possessed by a three-dimensional point cloud.

The learning unit 28 uses the three-dimensional point cloud A for learning in which a correct answer of an object corresponding to each point is known to learn the parameters of the inference model to minimize an error between a result of inference by the inference model and the correct answer. Specifically, the learning unit 28 uses a label of the correct class for each point in the three-dimensional point cloud A (hereinafter referred to as a “learning label”) as the correct answer. For example, the class here is the type of object, and in the case of an outdoor point cloud, it may be a road, a building, a utility pole, the ground, and the like. When there are U classes, a one-hot encoded L-point×U-dimensional learning label may be used for the three-dimensional point cloud A of L points. The learning label is stored in the learning label DB 36. The right side of FIG. 3 conceptually illustrates the learning label. In the example of FIG. 3, the class indicated by the learning label is represented by the pattern of points corresponding to each point in the three-dimensional point cloud A.

More specifically, the learning unit 28 receives the inference label from the inference unit 26 as input data, and acquires the learning label for the three-dimensional point cloud A that is the target of inference from the learning label DB 36. Then, the learning unit 28 updates the DNN parameters Pα, Pβ, and Pγ by backpropagation on the basis of the loss function calculated from the inference label (L points×U dimension) and the learning label (L points×U dimension). The learning unit 28 evaluates the error (loss function) using cross entropy, for example. The learning unit 28 ends the learning when the error between the inference label and the learning label is no longer smaller than all iterations, or when updating of the DNN parameters Pα, Pβ, and Pγ has been repeated a predetermined number of times.

The update unit 30 updates the densification parameter Pδ, which is applied when the densification unit 22 densifies the three-dimensional point cloud A, so that the accuracy of the position of each point included in the densified point cloud B increases. Specifically, the update unit 30 generates a plurality of patterns of parameter sets around the currently set densification parameter Pδ by adding or subtracting the value of the currently set densification parameter Pδ by a predetermined value, for example. The update unit 30 performs a series of processing in each of the densification unit 22, the search unit 24, and the inference unit 26 using the parameter set of each generated pattern and the DNN parameters Pα, Pβ, and Pγ obtained by the learning unit 28. Then, the update unit 30 updates the densification parameter Pδ with a parameter set of a pattern that minimizes the error between the inference label and the learning label. The update unit 30 ends the update when the error between the inference label and the learning label is no longer smaller than the previous iteration, or when updating of the densification parameter Pδ has been repeated a predetermined number of times. Accordingly, the densification parameter Pδ is updated.

In the densification method of a point cloud such as PTL 1 and NPL 3, parameters are updated so that the result of densifying a low-density point cloud becomes close to the correct high-density point cloud. However, this method requires a correct high-density point cloud that measures the same area as the low-density point cloud to update the parameters, and for this, a device that measures three-dimensional point clouds at high density is required. Therefore, parameters cannot be updated easily. In the present embodiment, if there is a learning label of a low-density three-dimensional point cloud prepared for learning DNN parameters for segmentation, the densification parameters can be updated without requiring the correct high-density point cloud.

Next, the operation of the three-dimensional point cloud segmentation device 10 according to the present embodiment will be described.

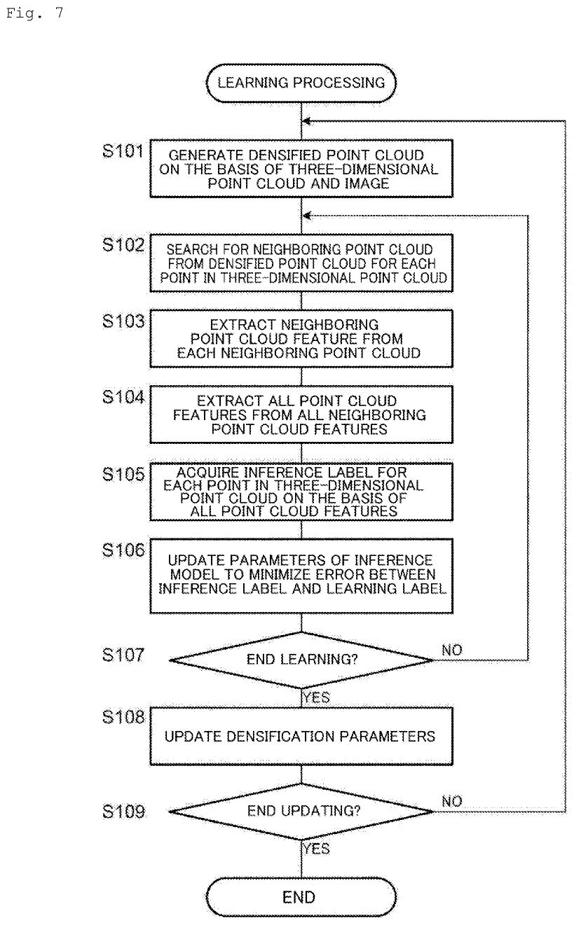

FIG. 7 is a flowchart illustrating a flow of learning processing by the three-dimensional point cloud segmentation device 10. The learning processing is performed by the CPU 11 reading out the three-dimensional point cloud segmentation program from the ROM 12 or the storage 14, loading the program into the RAM 13, and executing the program.

First, in step S101, the CPU 11, as the densification unit 22, generates a densified point cloud B by densifying the three-dimensional point cloud A by applying the densification parameter Pδ on the basis of the correspondence between the low-density three-dimensional point cloud A and the image A obtained by imaging a space including the three-dimensional point cloud A.

Next, in step S102, the CPU 11, as the search unit 24, searches for a neighboring point cloud C for each point in the three-dimensional point cloud A from the densified point cloud B.

Next, in step S103, the CPU 11, as the neighboring point cloud feature extraction unit 26a, uses DNNα independently for each point in the three-dimensional point cloud A to extract a neighboring point cloud feature F_C, which is a feature of the neighboring point cloud C found for each point.

Next, in step S104, the CPU 11, as the all point cloud feature extraction unit 26b, uses one DNNβ for the three-dimensional point cloud A to extract all point cloud features F, which are features for classifying the object corresponding to each point included in the three-dimensional point cloud A, from the neighboring point cloud features F_C.

Next, in step S105, the CPU 11, as the classification unit 26c, uses DNNγ for classifying the object corresponding to each point to acquire an inference label, which is a classification result of the object corresponding to each point included in the three-dimensional point cloud A, from the all point cloud feature F.

Next, in step S106, the CPU 11, as the learning unit 28, updates the values of the DNN parameters Pα, Pβ, and Pγ, which are the parameters of the inference model, to minimize the error between the inference label and the learning label for the three-dimensional point cloud A to be inferred.

Next, in step S107, the CPU 11, as the learning unit 28, determines whether or not to end learning of the parameters of the inference model. For example, it may be determined that the learning is ended when the error between the inference label and the learning label does not become smaller compared to the previous iteration, or when updating of the parameter has been repeated a predetermined number of times. When the learning is to be ended, the process moves to step S108, and when the learning is not to be ended, the process returns to step S102.

Next, in step S108, the CPU 11, as the update unit 30, generates a plurality of patterns of parameter sets around the currently set densification parameter Pδ. Further, the CPU 11, as the update unit 30, performs a series of processing in each of the densification unit 22, the search unit 24, and the inference unit 26 using the parameter set of each generated pattern and the DNN parameters Pα, Pβ, and Pγ obtained by the learning unit 28. Then, the CPU 11, as the update unit 30, updates the densification parameter Pδ with a parameter set of a pattern that minimizes the error between the inference label and the learning label.

Next, in step S109, the CPU 11, as the update unit 30, determines whether or not to end updating of the densification parameter Pδ. For example, it may be determined that the update is ended when the error between the inference label and the learning label is no longer smaller than the previous iteration, or when updating of the parameter has been repeated a predetermined number of times. When the update is not to be ended, the process returns to step S101, and when the update is to be ended, the learning processing ends.

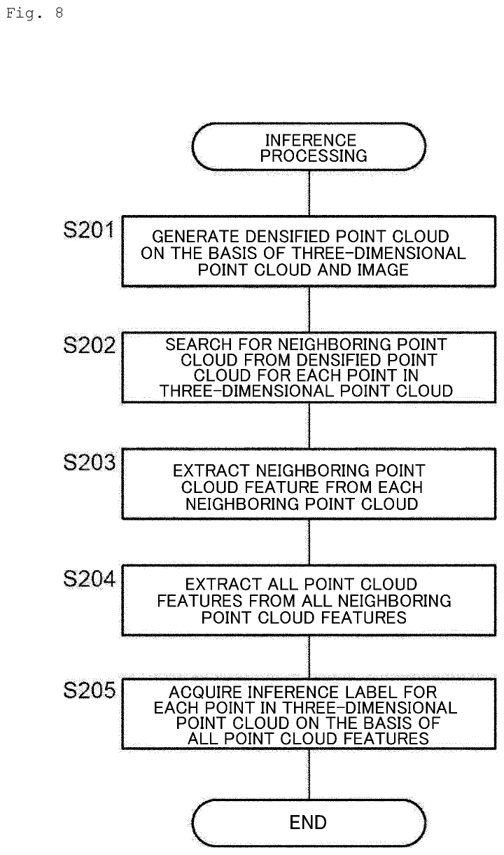

FIG. 8 is a flowchart illustrating a flow of inference processing executed by the CPU 11 of the three-dimensional point cloud segmentation device 10. When the CPU 11 reads out the three-dimensional point cloud segmentation program from the storage device 12, loads the program to the memory 13, and executes the program, the CPU 11 functions as each functional component of the three-dimensional point cloud segmentation device 10, and executes the inference processing illustrated in FIG. 8. Note that the inference processing is executed in a state in which the learned DNN parameters Pα, Pβ, and Pγ and the densification parameter Pδ are stored in the DNN parameter DB 42 and the densification parameter DB 38, respectively, by executing the above-described learning processing.

In steps S201 to S205, the CPU 11 executes processes similar to steps S101 to S105 of the above-described learning processing (FIG. 7) as the densification unit 22, the search unit 24, the neighboring point cloud feature extraction unit 26a, the all point cloud feature extraction unit 26b, and the classification unit 26c. Thus, an inference label for each point in the three-dimensional point cloud A to be inferred is acquired. In step S205, the CPU 11, as the classification unit 26c, stores the acquired inference label in the inference label DB 44, and the inference processing ends.

As described above, the three-dimensional point cloud segmentation device according to the present embodiment generates a densified point cloud having image-derived information by densifying a low-density three-dimensional point cloud using an image. In addition, the three-dimensional point cloud segmentation device searches for neighboring point clouds of each point in the three-dimensional point cloud from the generated densified point cloud, extracts its features, and uses the features to acquire an inference label that is a classification result of the object corresponding to each point in the three-dimensional point cloud. Thus, segmentation of a three-dimensional point cloud can be performed more accurately than when segmentation is performed on a three-dimensional point cloud based only on position information.

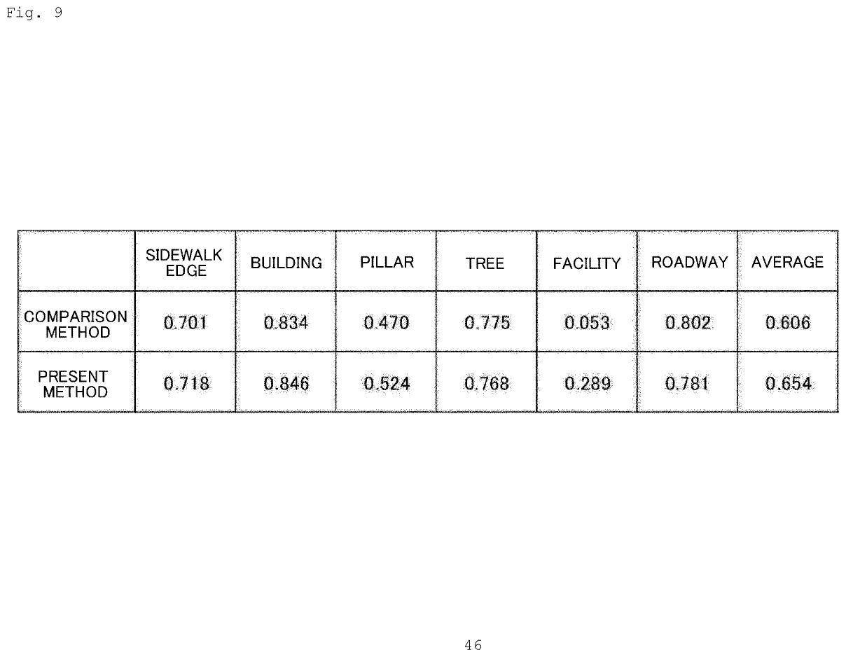

Here, experimental results using the three-dimensional point cloud segmentation device according to the present embodiment will be described with reference to FIG. 9.

FIG. 9 illustrates the accuracy comparison of segmentation results between a comparison method and a method of the present embodiment (hereinafter referred to as the “present method”). The comparison method is a method of performing segmentation using only a low-density three-dimensional point cloud measured by low-resolution LiDAR. Furthermore, as an index indicating accuracy, an intersection over union (hereinafter referred to as an “IOU”) indicating the degree of matching between the segmentation result and the correct answer (learning label) is used. Further, in FIG. 9, IOUs regarding the segmentation results of both methods are compared for each class.

As illustrated in FIG. 9, the IOU value of the present method is improved in many classes compared to the comparison method. That is, it can be seen that the three-dimensional point cloud segmentation device according to the present embodiment can perform more accurate segmentation.

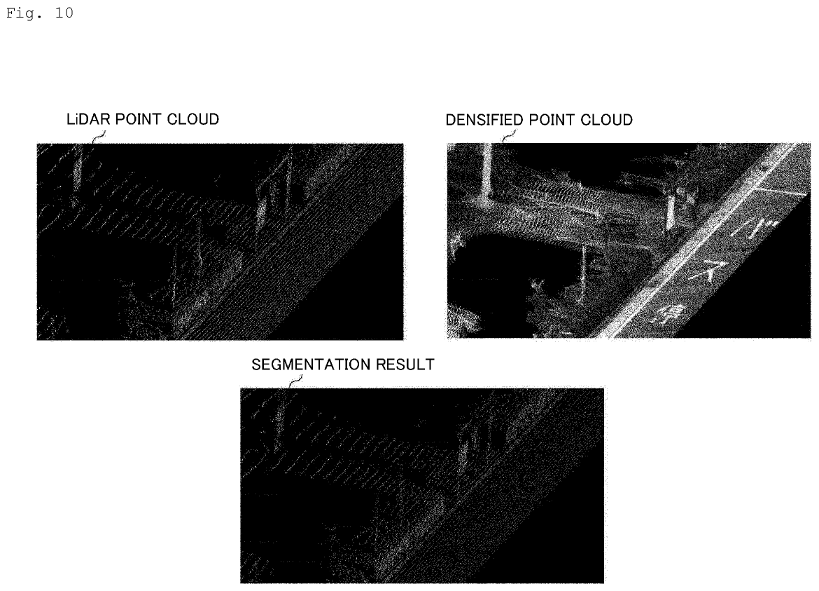

Further, FIG. 10 illustrates an example of a three-dimensional point cloud (LiDAR point cloud), a densified point cloud, and a segmentation result measured by low-resolution LiDAR. In the densified point cloud, each point actually has color information. Furthermore, the segmentation result is obtained by assigning a different color to each point in the LiDAR point cloud for each inferred class. It was found that each object was assigned a color representing the class of that object, allowing for more accurate segmentation.

In the above embodiment, a case has been described in which the unit of processing is one point cloud including L points, but the processing may be performed collectively as a batch. In this case, if the batch size is B, B three-dimensional point clouds each consisting of L points are processed at once.

Further, the learning processing and the inference processing executed in a case where the CPU reads software (program) in the above embodiment may be executed by various processors other than the CPU. Examples of processors used in such cases include a programmable logic device (PLD) such as a field-programmable gate array (FPGA) of which a circuit configuration can be changed after manufacturing and a dedicated electrical circuit that is a processor having a circuit configuration such as an application specific integrated circuit (ASIC) that is designed to execute specific processing. In addition, the learning processing and the inference processing may be executed by one of these various processors, or may be executed by a combination of two or more processors of the same type or different types (for example, a plurality of FPGAs, a combination of a CPU and an FPGA, and the like). Furthermore, a hardware structure of the various processors is, more specifically, an electrical circuit in which circuit elements such as semiconductor elements are combined.

Further, in the above embodiment, the aspect in which the three-dimensional point cloud segmentation program is stored (installed) in advance in the ROM or the storage has been described, but the present disclosure is not limited thereto. The program may be provided in a form recorded in a non-transitory recording medium such as a compact disk read only memory (CD-ROM), a digital versatile disc read only memory (DVD-ROM), and a Universal Serial Bus (USB) memory. Further, the program may be downloaded from an external device via a network.

Regarding the above embodiment, the following supplementary notes are further disclosed.

### (Supplementary Note 1)

A three-dimensional point cloud segmentation device including: a memory; and
at least one processor connected to the memory,
in which the processor is configured to:
search for neighboring point clouds for points included in a first three-dimensional point cloud, the points each having three-dimensional coordinates, from a second three-dimensional point cloud in which a density of points included is higher than that of the first three-dimensional point cloud, the points each having three-dimensional coordinates and information derived from an image; and
infer an object corresponding to each point included in the first three-dimensional point cloud on the basis of features extracted from the neighboring point clouds found by the search unit.

### (Supplementary Note 2)

A non-transitory recording medium having a program stored therein, the program executable by a computer to execute three-dimensional point cloud segmentation processing, in which the three-dimensional point cloud segmentation processing includes:
searching for neighboring point clouds for points included in a first three-dimensional point cloud, the points each having three-dimensional coordinates, from a second three-dimensional point cloud in which a density of points included is higher than that of the first three-dimensional point cloud, the points each having three-dimensional coordinates and information derived from an image; and
inferring an object corresponding to each point included in the first three-dimensional point cloud on the basis of features extracted from the neighboring point clouds found by the search unit.

### REFERENCE SIGNS LIST

10 Three-dimensional point cloud segmentation device

11 CPU

12 ROM

13 RAM

14 Storage

15 Input unit

16 Output unit

17 Communication I/F

19 Bus

22 Densification unit

24 Search unit

26 Inference unit

26a Neighboring point cloud feature extraction unit

26b All point cloud feature extraction unit

26c Classification unit

28 Learning unit

30 Update unit

32 Image/parameter DB

34 Three-dimensional point cloud DB

36 Learning label DB

38 Densification parameter DB

40 Densified point cloud DB

42 DNN parameter DB

44 Inference label DB

1. A three-dimensional point cloud segmentation device comprising:
a search unit that searches for neighboring point clouds for points included in a first three-dimensional point cloud, the points each having three-dimensional coordinates, from a second three-dimensional point cloud in which a density of points included is higher than that of the first three-dimensional point cloud, the points each having three-dimensional coordinates and information derived from an image; and
an inference unit that infers an object corresponding to each point included in the first three-dimensional point cloud on the basis of features extracted from the neighboring point clouds found by the search unit.

2. The three-dimensional point cloud segmentation device according to claim 1, further comprising a densification unit that generates the second three-dimensional point cloud by densifying the first three-dimensional point cloud on the basis of a correspondence between the first three-dimensional point cloud and an image obtained by imaging a space including the first three-dimensional point cloud.

3. The three-dimensional point cloud segmentation device according to claim 1, wherein the three-dimensional coordinates of each point included in the second three-dimensional point cloud have lower positional accuracy than the three-dimensional coordinates of each point included in the first three-dimensional point cloud.

4. The three-dimensional point cloud segmentation device according to claim 1, further comprising a learning unit that uses a first three-dimensional point cloud for learning in which a correct answer of an object corresponding to each point is known to learn parameters of an inference model used when inferring the object corresponding to each point to minimize an error between a result of inference by the inference model and the correct answer.

5. The three-dimensional point cloud segmentation device according to claim 2, further comprising an update unit that generates a plurality of patterns of parameter sets to be applied when the first three-dimensional point cloud is densified by the densification unit, and updates, when using the second three-dimensional point cloud that has been densified by applying each parameter set of the plurality of patterns to a first three-dimensional point cloud for learning in which a correct answer of an object corresponding to each point is known, the parameter sets of the densification unit with a parameter set of a pattern that minimizes an error between a result of inference by an inference model used when inferring the object corresponding to each point and the correct answer.

6. The three-dimensional point cloud segmentation device according to claim 1,
wherein the inference unit includes:
a neighboring point cloud feature extraction unit that uses a first feature extractor independently for each point included in the first three-dimensional point cloud to extract features of the neighboring point clouds found for the points;
an all point cloud feature extraction unit that uses one second feature extractor for the first three-dimensional point cloud to extract features for classifying the object corresponding to each point included in the first three-dimensional point cloud from the features of all the neighboring point clouds extracted by the neighboring point cloud feature extraction unit; and
a classification unit that uses a classifier for classifying the object corresponding to each point to classify the object corresponding to each point included in the first three-dimensional point cloud from the features extracted by the all point cloud feature extraction unit.

7. A three-dimensional point cloud segmentation method comprising:
searching for, by a search unit, neighboring point clouds for points included in a first three-dimensional point cloud, the points each having three-dimensional coordinates, from a second three-dimensional point cloud in which a density of points included is higher than that of the first three-dimensional point cloud, the points each having three-dimensional coordinates and information derived from an image; and
inferring, by an inference unit, an object corresponding to each point included in the first three-dimensional point cloud on the basis of features extracted from the neighboring point clouds found by the search unit.

8. (canceled)

9. The three-dimensional point cloud segmentation method according to claim 7, further comprising:
generating the second three-dimensional point cloud by densifying the first three-dimensional point cloud on the basis of a correspondence between the first three-dimensional point cloud and an image obtained by imaging a space including the first three-dimensional point cloud.

10. The three-dimensional point cloud segmentation method according to claim 7, wherein the three-dimensional coordinates of each point included in the second three-dimensional point cloud have lower positional accuracy than the three-dimensional coordinates of each point included in the first three-dimensional point cloud.

11. The three-dimensional point cloud segmentation method according to claim 7, further comprising:
learning using a first three-dimensional point cloud in which a correct answer of an object corresponding to each point is known to learn parameters of an inference model used when inferring the object corresponding to each point to minimize an error between a result of inference by the inference model and the correct answer.

12. The three-dimensional point cloud segmentation method according to claim 7, further comprising:
generating a plurality of patterns of parameter sets to be applied when the first three-dimensional point cloud is densified by the densification unit, and updates, when using the second three-dimensional point cloud that has been densified by applying each parameter set of the plurality of patterns to a first three-dimensional point cloud for learning in which a correct answer of an object corresponding to each point is known, the parameter sets of the densification unit with a parameter set of a pattern that minimizes an error between a result of inference by an inference model used when inferring the object corresponding to each point and the correct answer.

13. The three-dimensional point cloud segmentation method according to claim 7,
wherein the inference unit:
using a first feature extractor independently for each point included in the first three-dimensional point cloud to extract features of the neighboring point clouds found for the points;
using one second feature extractor for the first three-dimensional point cloud to extract features for classifying the object corresponding to each point included in the first three-dimensional point cloud from the features of all the neighboring point clouds extracted by the neighboring point cloud feature extraction unit; and
classifying the object corresponding to each point to classify the object corresponding to each point included in the first three-dimensional point cloud from the features extracted by the all point cloud feature extraction unit.

14. A computer-readable non-transitory recording medium storing computer-executable program instructions that when executed by a processor cause a computer to execute a three-dimensional point cloud segmentation method comprising:
searching for, by a search unit, neighboring point clouds for points included in a first three-dimensional point cloud, the points each having three-dimensional coordinates, from a second three-dimensional point cloud in which a density of points included is higher than that of the first three-dimensional point cloud, the points each having three-dimensional coordinates and information derived from an image; and
inferring, by an inference unit, an object corresponding to each point included in the first three-dimensional point cloud on the basis of features extracted from the neighboring point clouds found by the search unit.

15. The computer-readable non-transitory recording medium according to claim 14 wherein the three-dimensional point cloud segmentation method further comprising:
generating the second three-dimensional point cloud by densifying the first three-dimensional point cloud on the basis of a correspondence between the first three-dimensional point cloud and an image obtained by imaging a space including the first three-dimensional point cloud.

16. The computer-readable non-transitory recording medium according to claim 14 wherein the three-dimensional point cloud segmentation method further comprising the three-dimensional coordinates of each point included in the second three-dimensional point cloud have lower positional accuracy than the three-dimensional coordinates of each point included in the first three-dimensional point cloud.

17. The computer-readable non-transitory recording medium according to claim 14 wherein the three-dimensional point cloud segmentation method further comprising:
learning using a first three-dimensional point cloud in which a correct answer of an object corresponding to each point is known to learn parameters of an inference model used when inferring the object corresponding to each point to minimize an error between a result of inference by the inference model and the correct answer.

18. The computer-readable non-transitory recording medium according to claim 14 wherein the three-dimensional point cloud segmentation method further comprising:
generating a plurality of patterns of parameter sets to be applied when the first three-dimensional point cloud is densified by the densification unit, and updates, when using the second three-dimensional point cloud that has been densified by applying each parameter set of the plurality of patterns to a first three-dimensional point cloud for learning in which a correct answer of an object corresponding to each point is known, the parameter sets of the densification unit with a parameter set of a pattern that minimizes an error between a result of inference by an inference model used when inferring the object corresponding to each point and the correct answer.

19. The computer-readable non-transitory recording medium according to claim 14 wherein the three-dimensional point cloud segmentation method further comprising:
the inference unit, wherein the inference unit:
uses a first feature extractor independently for each point included in the first three-dimensional point cloud to extract features of the neighboring point clouds found for the points;
uses one second feature extractor for the first three-dimensional point cloud to extract features for classifying the object corresponding to each point included in the first three-dimensional point cloud from the features of all the neighboring point clouds extracted by the neighboring point cloud feature extraction unit; and
classifies the object corresponding to each point to classify the object corresponding to each point included in the first three-dimensional point cloud from the features extracted by the all point cloud feature extraction unit.
